(19) United States
(12) Patent Application Publication
(10) Pub. No.: US 2021/0310647 A1
(43) Pub. Date: Oct. 7, 2021

(54) Folded fin heat dissipation system and method for light emitting diodes

(71) Applicants: Thomas Peter Werner, Powell, OH (US); Victor Anthony Liguore, Youngstown, OH (US); Mark Frederick Haushalter, Bellefontaine, OH (US); David Leo Haushalter, Kenton, OH (US)

(72) Inventors: Thomas Peter Werner, Powell, OH (US); Victor Anthony Liguore, Youngstown, OH (US); Mark Frederick Haushalter, Bellefontaine, OH (US); David Leo Haushalter, Kenton, OH (US)

(73) Assignee: Adaptive Thermal Solutions, LLC, Kenton, OH (US)

(21) Appl. No.: 15/530,914

(22) Filed: Mar. 21, 2017

(51) Int. Cl. F21V 29/74; F21K 9/90

(52) U.S. Cl. CPC F21V 29/74; F21Y 2115/10; F21K 9/90

(57) ABSTRACT

The present invention relates to heat dissipation for multiple light emitting diode (LED) applications using folded fin. The heat dissipation system and method of the present invention uses a folded fin structure to provide progressive thermal management strategies for high power LED light sources. The LED light sources are attached to the folded fin structure by any suitable means, including but not limited to ultrasonic welding, linear welding, torsion welding, brazing, soldering, clipping or otherwise mechanically attaching, adhesion means, or combinations thereof. The folded fin structure as the heat transfer management strategy for high power LED light sources provides enhanced performance with reduced weight and space requirements.

### TECHNICAL FIELD

The present invention relates to heat dissipation for multiple light emitting diode (LED) applications using folded fin, and, more particularly, to progressive thermal management strategies for high power LED light sources, utilizing folded fin.

### BACKGROUND ART

With the advent of LEDs into multiple lighting fields, LEDs have become one of the standard methods of producing light, joining more traditional sources such as incandescent, fluorescent and high-intensity discharge. Technological developments in the area of high-power LED light sources have enabled their utilization in general illumination applications. However, along with this advancement comes the need for progressive thermal management strategies in order to ensure device performance and reliability. A unique aspect of LED lighting, as compared to traditional lighting sources, is the fact that the source of light is a semiconductor, not a filament or gas discharge or arc. This requires a change in the technology associated with the thermal challenges presented by this structure.

Heat transfer for semiconductors presents a conduction challenge. With LED junction temperatures limited in many cases to less than 100 degrees Celsius, conduction is the primary transfer method. Instead of most of the thermal energy leaving the source by radiation as compared to traditional lighting sources, the thermal energy of an LED system leaves via the fixture at a much lower temperature with a mix of natural convection and some radiation. This change in the cooling design is an inherent stumbling block in advancements in the field of high-power LED lighting. A suitable path for conducting heat from the LEDs must be provided. Minimizing an LED's junction temperature is done by minimizing the total system's thermal resistance. In the existing art this includes various thermal interfaces which can have poor contact between parts, and base plate fixtures which add weight and bulk to the entire lighting structure.

Furthermore, the cooling means for high power LED lighting systems presents additional challenges and constraints. LED lighting system arrangements are typically driven by the geometry and manufacturability involved with and required by each particular lighting industry, as well as functional and regulatory constraints in the various industries utilizing lighting systems, influencing the original design of replacement LED fixtures.

Most lighting is already in some form of a housing, and the need and desire to concurrently optimize these housings for thermal and optical performance has already started to accelerate the widespread design and implementation of cost-efficient, environmentally friendly, solid-state lighting. LED lighting is desirable in many industries due to its small size and distinctive look. For example, LED lighting allows automotive design engineers to be more creative in their approach to how car headlights look and function. LED headlamps can take advantage of their directional sources and reflect every part of the output at least once. However, all of the functionality of LEDs comes at a price. Brighter, more functional, LED systems require more power, and get hot very quickly. Heat is the bane of LEDs, shortening lifetime, damaging brightness, degrading efficiency, and diminishing color—all unacceptable consequences in forward illumination, conspicuity, signal and identification lights, where safety concerns are paramount. These same consequences, while not as potentially life-threatening as in the automotive or aerospace industries, are still present and undesirable in other lighting-related industries.

Because LEDs are changing the world of lighting due to efficiencies, size, brightness, durability, and lifetime cost, it is seen then that there exists a need for heat transfer and thermal management strategies to efficiently and effectively dissipate the heat from LED devices and particularly from high power LED devices.

### SUMMARY OF THE INVENTION

This need is met by the system and method according to the present invention, wherein a heat dissipation structure provides lightweight, space-constrained, high-performance, low-cost heat dissipation in confined LED assemblies.

The current invention is achieving heat transfer by attaching the LED chip or light board to a folded fin structure. In the current art, heat sinks are often die cast or extruded aluminum, magnesium or brass alloys which are laborious to form and result in heavy heat sinks with limited heat transfer capability and constraints in fins per inch adjustment. The present invention uses a folded fin structure with its concomitant foldable material such as copper or aluminum, resulting in a greater heat transfer surface area with less weight. Foldable fin allows for so much more design variation and heat transfer capability. For instance, it is a lighter weight heat transfer device as compared to die cast or extruded heat sinks, and it takes up less space to achieve the same or improved thermal management. Besides being cost effective and more efficient, this design has the very desirable advantage of being lightweight and high-performing. In the automotive industry, each lighting assembly has multiple heat dissipating structures, so the weight of the existing die cast material fixtures is quite measurable. Weight savings in any lighting industry cannot be overemphasized. Every pound of weight saved provides cost savings in structure and installation, as well as directional design options. In the automotive industry, every pound of weight saved improves fuel mileage. Each head lamp and each tail light has multiple heat dissipating structures, so the quantity of potential weight-saving fixtures is quite measurable. As a result of the present invention, alternative types of headlamps that combine high beams, low beams, signal and identification lights, conspicuity, and even lights that corner can be explored in the automotive industry. However, unlike traditional headlamps which throw heat forward and away as infra-red radiation, LEDs need to lose heat by conduction from behind, and in very tight design compartments, usually by semiconductor-style heat sinking. The present invention successfully responds to this design constraint by utilizing folded fin to address the current art problems of excess heat in LED lighting applications.

In accordance with the present invention, an LED chip or package is fastened by any of a variety of suitable means to a folded fin structure. In one embodiment, particularly suited to after-market applications, an LED heat sink with an associated metal core printed circuit board (MCPCB) using folded fin can simply replace the existing die cast heat sink, with less weight and greater surface area for heat transfer. Because folded fin weighs less and can be designed with tighter fins per inch tolerances, the surface area for heat transfer from the LED is improved, with less resultant weight. The attachment means can be weld, solder, braze, adhesive, mechanical fastening, tapping, or any combination of these or other suitable attachment or fastening means. Because folded fin is lighter weight, it may utilize a spreader plate to maintain the desired fins per inch tolerances, and this spreader plate can be incorporated as part of the attachment or fastening means. In another embodiment of the present invention, particularly suited to new product development or front-end innovation, the base plate can be completely eliminated and the LED chip or package—or the MCPCB with the attached LED unit—can be directly attached to the spreader plate for even more improved heat transfer and reduced weight.

Accordingly, it is an object of the present invention to provide a heat dissipation system and method for LED applications, particularly high-powered LED applications. It is an advantage of the present invention that the heat dissipation is high performance, low cost and lightweight. The present invention provides the further advantage of using folded fin with its synergistic high performance heat dissipation. It is a feature of the present invention that it provides particular usefulness in lighting applications with space and weight constraints.

Other objects and advantages of the invention will be apparent from the following description, the accompanying drawings and the appended claims.

### BRIEF DESCRIPTION OF THE DRAWINGS

In the drawings:

FIGS. 1A and 1B are isometric and front views, respectively, of an LED unit attached to a folded fin structure, in accordance with one embodiment of the present invention;

FIGS. 2A and 2B are isometric and front views, respectively, of an LED unit attached to a folded fin structure, in accordance with an alternative embodiment of the present invention;

FIGS. 3A and 3B are isometric and front views, respectively, of an LED chip with an associated MCPCB attached to a folded fin structure, in accordance with one embodiment of the present invention;

FIG. 4 is an exploded side view of an after-market embodiment of the present invention;

FIGS. 5A, 5B and 5C are exploded side views of front-end innovation embodiments of the present invention using plain folded fin; and

FIG. 6 is an exploded cutaway view of an alternative front-end innovation embodiment of the present invention using a radial folded fin.

### DETAILED DESCRIPTION OF THE PREFERRED EMBODIMENTS

The present invention uses folded fin as the heat transfer management strategy for high power LED light sources to provide enhanced performance with reduced weight and space requirements. Folded fin provides many heretofore unrealized advantages in a heat dissipation system and method for LEDs. Folded fin is lighter weight and takes up less space than existing LED heat sink assemblies, making the present invention particularly advantageous in applications where size and weight are of paramount concern. The fin tolerances for the given area can be much tighter, since the fins can be formed much closer together than is possible with die cast or extruded heat sinks. The material thickness is also adjustable with folded fin, as is the actual formed structure. For example, the measured fins per inch, or fins per given area, at the top of the folded fin does not need to be equal to the measured fins per inch or given area at the bottom of the folded fin structure. This allows the unique advantage of being able to eliminate a base plate by pushing together fins at the top to create a spreader plate base. These functional and design opportunities of folded fin in accordance with the teachings of the present invention make the introduction of folded fin extremely advantageous in the LED lighting industries.

The heat dissipation system and method of the present invention is applicable to many decorative, consumer, and commercial lighting industries, including automotive, aerospace, municipal lighting such as street lights and stop lights, medical lighting, agricultural lighting and multiple other industrial applications. The present invention provides several embodiments of folded fin applications in LED lighting-related industries.

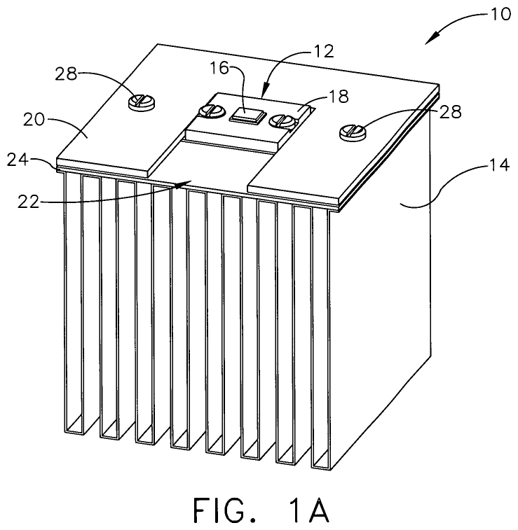

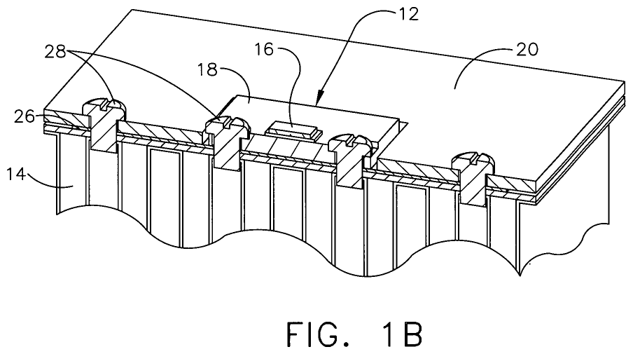

Referring now to the drawings, FIGS. 1A and 1B illustrate isometric and front views, respectively, of a structure 10 comprising an LED unit 12 attached to a folded fin structure 14, in accordance with one embodiment of the present invention. The folded fin structure can be any of a variety of folded fin arrangements, including plain, lanced, louvered, ruffled, wavy, bump, radial, or any other fin design that meets the heat transfer requirements of a particular industry. Each folded fin can provide various advantages. For example, a wavy folded fin might provide additional rigidity; a radial folded fin might provide more surface area; a plain folded fin might be most cost effective.

The folded fin 14 is the primary heat transfer component, and the folded fin 14 material can be any of a variety of suitable materials. For example, Copper might be selected because it is an excellent conductor of heat. Its high thermal conductivity allows heat to pass through it quickly in applications where that speed of transfer is necessary. Alternatively, Aluminum might be selected in applications where weight is the bigger design concern. The corrosion-resistant properties of Nickel make it an option for use in salty or corrosive environments.

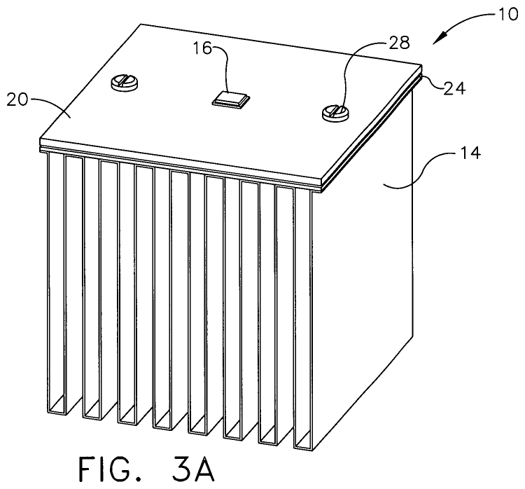

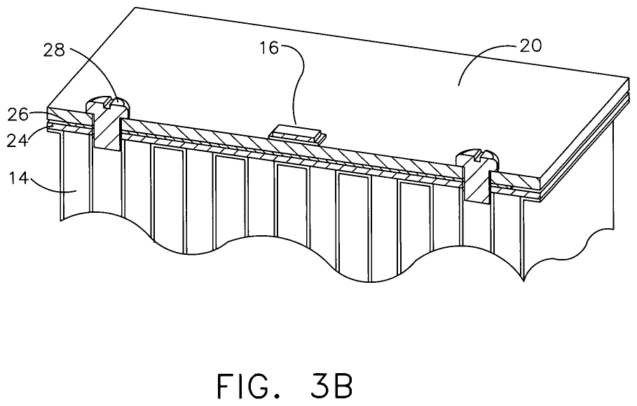

Continuing with FIGS. 1A and 1B, the LED unit 12 comprises an LED chip 16 associated with an LED carrier package 18. In any LED application, the LED chip 16 or the LED unit 12 is associated with a substrate or power source such as a metal core printed circuit board 20. In the particular embodiment of FIGS. 1A and 1B, the MCPCB has a cut out section 22 for receiving the LED package 12. Alternatively, the LED chip 16 could be surface mounted directly on the MCPCB 20, as illustrated in FIGS. 3A and 3B, described in more detail below.

The embodiment illustrated in FIGS. 1A and 1B comprises a base plate 24. Spreading or constriction resistances exist when heat is flowing from one region to another. When a heat source of a smaller footprint, such as the LED unit 12, is mounted to the folded fin 14, there is going to be a higher local temperature at the location where the heat source 12 is placed. The base plate 24 can be included as the mounting substrate for the LED unit 12 to allow the heat to spread in a calculable spreading resistance area. The folded fin 14 can be brazed to the base plate 24 and the LED unit 12 can be attached to the MCPCB 20 or directly to the base plate 24 if the MCPCB 20 has the cut out section 22. Consequently, any of the components including the MCPCB 20 or the base plate 24, or even the surface of the folded fin 14 if the fins per inch allow can be used as the heat spreader means for dissipating heat from the LED unit 12. Furthermore, an additional thermal layer or dielectric material 26 can be used to enhance the thermal management of the structure 10. The LED unit 12, the MCPCB 20, or both, can be further secured to the folded fin 14 or folded fin base plate 24 by using tapping means 28 in any desired number of locations. Another embodiment of the present invention provides for ultrasonic welding of the folded fin 14 to the spreader plate, whereby the spreader plate can be a tangibly separate layer, or inherent in the folded fin 14 construction.

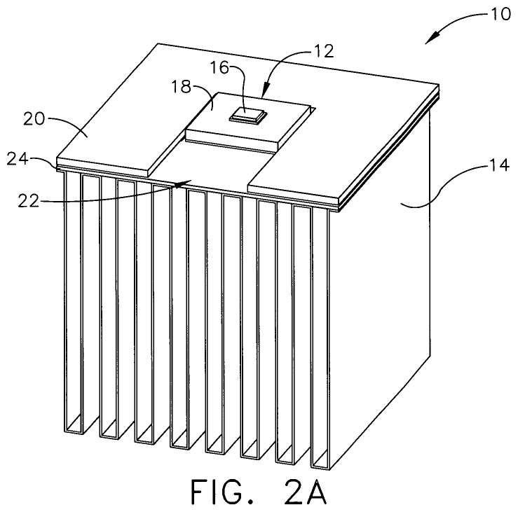

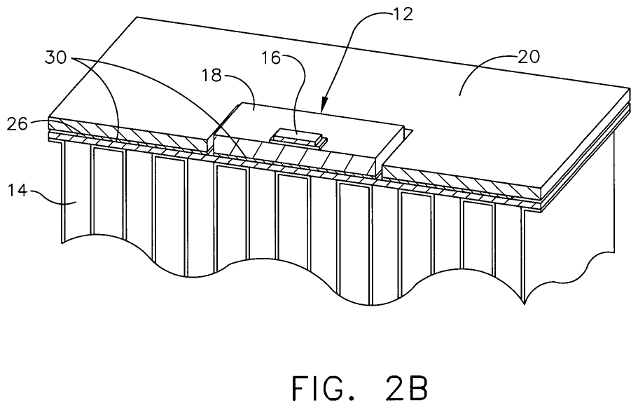

As illustrated in FIGS. 2A and 2B, the tapping means 28 is only one embodiment for securement of the structure 10 for enhanced thermal management in accordance with the present invention. Ultrasonic welding can be used to create a solid-state weld by localized application of high frequency ultrasonic acoustic vibrations. For normal geometry fin, linear welding can be used to keep a majority of the vibrations from entering the LED unit 12 substrate 20. For radial fins, torsion welding can work by reducing the vibrations transferred to the substrate 20. As those skilled in the art will certainly recognize, multiple variations of the materials and attachment means can be applied without departing from the scope of the invention wherein folded fin is used to dissipate heat from LEDs.

The isometric view of FIG. 2A and the front view of FIG. 2B illustrate the same concept of achieving progressive thermal management strategies for high power LED 16 light sources using folded fin 14. In FIGS. 2A and 2B, a solder joint 30 is used to solder or braze the base plate 24 to the folded fin 14. The choice between the variety of suitable attachment means can depend on a number of varying factors, such as cost or heat transfer requirements. For example, a solder joint 30 might be chosen if the folded fin is Copper or its equivalent, whereas Aluminum folded fin might be more conducive to fastener methods such as thermal adhesion, or mechanical fastening means such as a clip or hole taps as illustrated by tapping means 28.

Alternatively, in yet another arrangement that still embodies the teachings of the present invention, FIGS. 3A and 3B are isometric and front views, respectively, of the structure 10 showing an LED chip 16 independent of the LED carrier package 18, with the associated MCPCB 20 attached to the folded fin 14. Although FIGS. 3A and 3B show the LED chip 16 attached directly to the MCPCB 20, those skilled in the art will recognize that the enhanced heat transfer provided by utilizing the folded fin 14 structure can still be achieved whether the LED chip 16 is surface mounted to the MCPCB 20 as shown, or attached to a base plate 24 via the cutout portion 22 as illustrated in FIGS. 1A, 1B, 2A and 2B. Furthermore, the same suitable variety of attachment means including but not limited to brazing, soldering, tapping, adhesive, ultrasonic or other methods of welding, can all be used singularly or in multiple combinations, to attach the LED chip 16—or the LED unit 12—to the folded fin 14. For exemplary purposes only, a pair of tapped means 28 and a dielectric material layer 26 are shown in FIGS. 3A and 3B.

The present invention introduces folded fin to achieve heat transfer for applications heretofore quite challenging. Brighter, more functional LED systems require more power, and get hot very quickly. This heat can shorten LED lifetime, diminish brightness, degrade efficiency, deteriorate conspicuity, and corrupt color—all unacceptable consequences in headlights, tail lights, turn signals, and brake lights, where safety concerns are paramount. These same consequences, while not as potentially life-threatening as in the automotive or aerospace industries, are still present and undesirable in other lighting-related industries. All of these issues are addressed by utilizing folded fin in accordance with the teachings of the present invention. The concept of utilizing folded fin is the crux of the invention. The folded fin can be manufactured according to any necessary specifications, and the attachment means can vary depending on the desired outcomes. In a preferred embodiment of the present invention, the fin is likely to be in the range of approximately 8 fins per linear inch with any suitable thickness such as, for example, 0.020 of an inch, for many LED cooling applications.

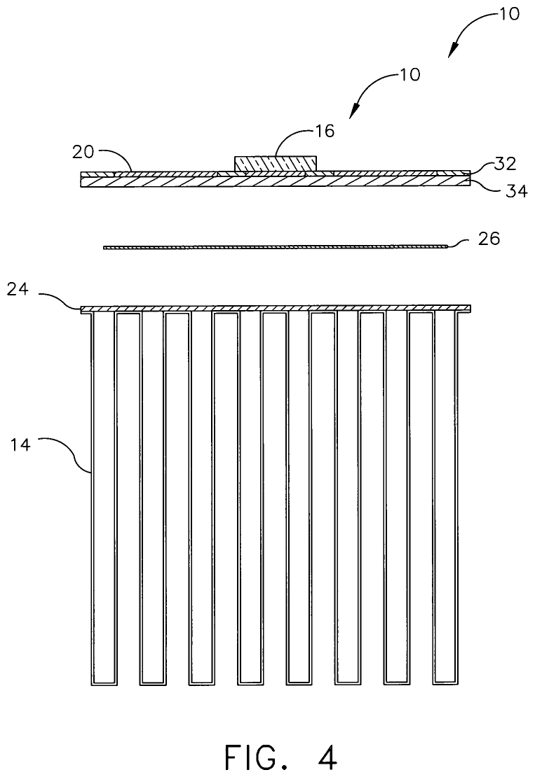

Referring now to FIG. 4, there is illustrated an exploded side view of an embodiment of the present invention particularly suited to an after-market application. An existing die cast heat sink for a high power LED 16 could be simply replaced with the appropriate size and shape of a heat transfer structure 10 in accordance with the teachings of the subject invention. In FIG. 4, the LED chip is in conjoined with the folded fin 14 via a copper layer 32 which is a typical layering material in the fabrication of the MCPCB 20, and an aluminum spreader plate 34. For exemplary purposes only, and not to be considered as limiting the scope of the invention, an adhesive layer 26 and a base plate 24 are also shown in the exploded view as means for forming the structure 10. In this embodiment, the folded fin 14 can be brazed or otherwise attached to the base plate 24. The use of the folded fin 14 provides the enhanced heat transfer capabilities as compared to the existing art of using die cast heat transfer channels.

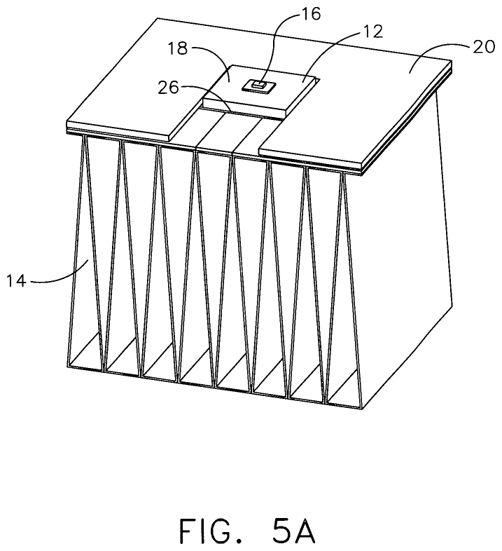

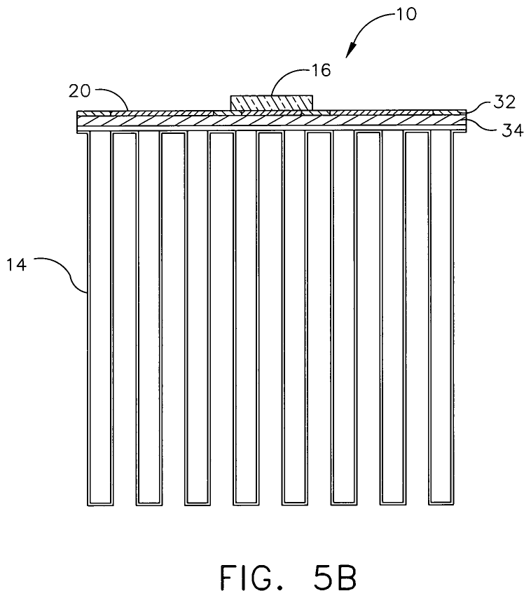

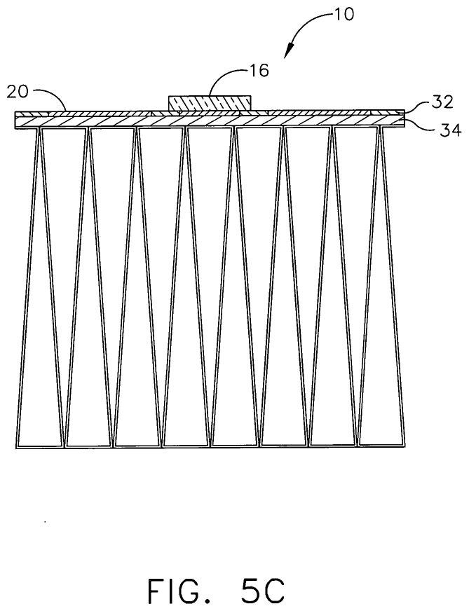

Referring now to FIGS. 5A, 5B and 5C and continuing with FIG. 4, an embodiment particularly suited to a front-end innovation embodiment of the present invention is illustrated. In FIG. 5A, the base plate 24 and the spreader plate 34 have been eliminated and the folded fin 14 is directly attached by brazing or soldering or welding or other suitable means to the substrate or MCPCB 20. The LED package could be attached directly to the folded fin, minus the spreader plate, preferably with the fins squeezed together to form a surface. The folded fin could also be welded to the back side of the MCPCB 20. Alternatively, the embodiment illustrated in FIG. 5B shows the spreader plate 34 as an attachment surface for the folded fin 14, without the need for a base plate 24. When the MCPCB 20 is made from layered materials with the last material being the aluminum plate 34, the attachment transition could be thermal epoxy or a low temperature solder. Finally, in FIG. 5C, the fins per inch at the top of the folded fin 14 are squeezed together to form an integral spreader surface allowing attachment of the folded fin 14 directly to the MCPCB 20 or even the LED unit 12.

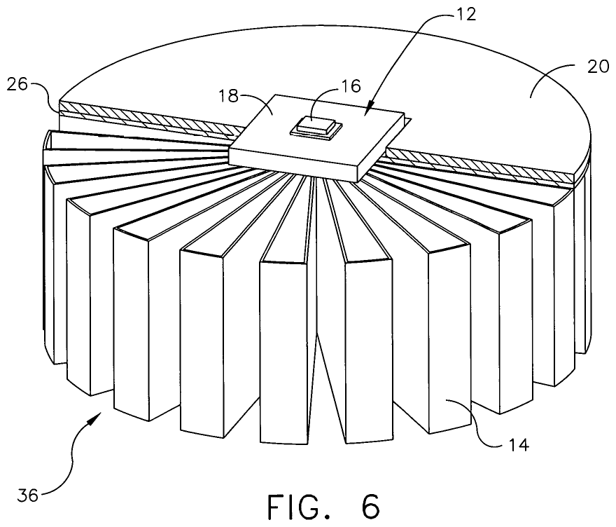

Finally, in FIG. 6, there is illustrated an alternative folded fin embodiment. FIG. 6 shows a folded radial fin structure 36. As stated above, the folded fin 14 can be any of a variety of folded fin arrangements, including plain, lanced, louvered, ruffled, wavy, bump, radial, or any other fin design that meets the heat transfer requirements of a particular industry. For purposes of explanation only, the previous examples illustrate plain folded fin, which can provide ease in manufacturing giving resultant cost advantages. Other folded fin arrangements can provide added stiffness to the structure, or more surface area for heat transfer. For example, the performance of a radial heat sink such as is illustrated in FIG. 6 can be superior to a rectangular heat sink because there is heat flow (cooling) from every direction. With rectangular heat sinks, as with certain folded fin configurations, there are only three directions of flow. Also, radial design lends well to attaching a fan to help with the flow. In accordance with the present invention, however, all folded fin configurations provide the significant advantage of weight reduction along with the progressive thermal and weight management strategies.

The present invention provides a reliable, high performance, low cost, heat dissipation system and method for light emitting diodes, that utilizes folded fin to achieve progressive thermal management. The invention has been described in detail with particular reference to certain preferred embodiments thereof, but it will be understood that modifications and variations can be effected within the spirit and scope of the invention.

What we claim as new and desire to secure by Letters Patent of the United States is:

1. A method for dissipating heat from an LED light source comprising the steps of:
a) providing a folded fin heat transfer structure; and
b) attaching said LED light source to said folded fin heat transfer structure.

2. A method as claimed in claim 1 wherein the LED light source is a high power LED light source.

3. A method as claimed in claim 1 wherein the folded fin heat transfer structure is comprised of plain folded fin.

4. A method as claimed in claim 1 wherein the folded fin heat transfer structure is comprised of radial folded fin.

5. A method as claimed in claim 1 further comprising the step of providing a base plate situated between the folded fin and the LED light source.

6. A method as claimed in claim 1 further comprising the step of providing a spreader plate situated between the folded fin and the LED light source.

7. A method as claimed in claim 6 further comprising the step of integrating the spreader plate with the folded fin by squeezing the top fins together to form a continuous surface.

8. A method as claimed in claim 1 wherein said step of attaching further comprises the step of ultrasonic welding.

9. A method as claimed in claim 1 wherein said step of attaching further comprises the step of brazing.

10. A method as claimed in claim 1 wherein said step of attaching further comprises the step of soldering.

11. A method as claimed in claim 1 wherein said step of attaching further comprises the step of applying an adhesion layer.

12. A method as claimed in claim 1 wherein said step of attaching further comprises the step of mechanically attaching.

13. A system for dissipating heat from an LED light source comprising:
a) a folded fin heat transfer structure; and
b) attachment means for attaching said LED light source to said folded fin heat transfer structure.

14. A system as claimed in claim 13 wherein the LED light source is a high power LED light source.

15. A system as claimed in claim 13 wherein the folded fin heat transfer structure is comprised of plain folded fin.

16. A system as claimed in claim 13 wherein the folded fin heat transfer structure is comprised of radial folded fin.

11. A method as claimed in claim 1 wherein said step of attaching further comprises the step of applying an adhesion layer.

12. A method as claimed in claim 1 wherein said step of attaching further comprises the step of mechanically attaching.

13. A system for dissipating heat from an LED light source comprising:
a) a folded fin heat transfer structure; and
b) attachment means for attaching said LED light source to said folded fin heat transfer structure.

14. A system as claimed in claim 13 wherein the LED light source is a high power LED light source.

15. A system as claimed in claim 13 wherein the folded fin heat transfer structure is comprised of plain folded fin.

16. A system as claimed in claim 13 wherein the folded fin heat transfer structure is comprised of radial folded fin.

17. A system as claimed in claim 13 further comprising a base plate situated between the folded fin and the LED light source.

18. A system as claimed in claim 13 further comprising a spreader plate situated between the folded fin and the LED light source.
